(19) United States
(12) Patent Application Publication
(10) Pub. No.: US 2010/0067715 A1
(43) Pub. Date: Mar. 18, 2010

(54) Combined lighting fixture & sound unit powered by the same electric wiring

(76) Inventor: Lawrence Bibi, Jersey City, NJ (US)

Correspondence Address: EZRA SUTTON & ASSOCIATES, P.A., SUITE 201, 900 ROUTE 9 NORTH, WOODBRIDGE, NJ, 07095, US

(21) Appl. No.: 12/386,734

(22) Filed: Apr. 22, 2009

Related U.S. Application Data
(60) Provisional application No. 61/136,577, filed on Sep. 16, 2008.

(51) Int. Cl. H04B 3/00

(52) U.S. Cl. 381/77

(57) ABSTRACT

In accordance with the present invention, there is provided a family of lighting fixtures (Hard Wired or Portable) that are based on Home Plug Technology. Each lighting fixture has lights and speakers built into a single unit. Once installed in the home or building, the system transmits audio, video, and electrical signals via existing standard AC electrical wiring, without any audio wiring.

A base station transmits audio or video signals through the home or office building standard AC electrical wiring, and delivers the signals to the combined lighting and speaker fixtures.

This technology is built into ceiling mounted light fixtures, wall sconces, vanity lighting, track lighting, wall mounted mirrors, outdoor lighting, portable lighting torcheres, or table lamps.

A Home Plug transmitter chip sends the signals to a receiver chip in the lighting products. The home plug functionality is provided by simply plugging the base station into an existing AC outlet.

To automate all of the lighting fixtures in the home using this system, a simple program on a laptop is provided to control every light fixture in the house to set up a lighting scheme. This provides the ability to have complete home lighting automation without any special wiring or lighting panel.

### PRIOR APPLICATION

This application is based on and claims priority from provisional application No. 61/136,577 filed on Sep. 16, 2008.

### FIELD OF THE INVENTION

The present invention relates to a combination of lighting fixtures each having a built in speaker unit, which are powered by standard electrical AC wiring, without any audio wiring. The audio data signal is sent through the AC power grid network by an Arkados receiver chip located within each lighting-speaker unit. The audio data signal is transmitted from a transmitter chip in the base station to the Arkados receiver chip in each lighting-speaker unit. The base station receives and docks an iPod unit.

### BACKGROUND OF THE INVENTION

Present lighting fixtures and speaker units normally use separate electric and audio wires for transmitting electric power and audio signals. The present invention eliminates this so that the combined lighting fixture and speaker units are powered by standard electrical AC wiring, without any audio wires. The audio signals are transmitted over the standard electrical wiring.

### DESCRIPTION OF THE PRIOR ART

The prior art does not disclose or teach the concept the present invention.

The prior art does not teach or disclose the design, configuration and structure of a light and sound system for transmitting audio/data signals over electrical wires, with the system being connected to the internet, as well as various lighting fixtures, and a control panel for controlling the system.

Accordingly, it is an object of the present invention to provide a combination lighting fixture with built-in audio speakers in the same fixture or unit, which are both powered by standard electrical AC wiring, without any audio wiring.

### SUMMARY OF THE INVENTION

In accordance with the present invention, there is provided a family of lighting fixtures (Hard Wired or Portable) that are based on Home Plug Technology. Each lighting fixture has lights and speakers built into a single unit. Once installed in the home or building, the system transmits audio, video, and electrical signals via existing standard AC electrical wiring, without any audio wiring.

A base station transmits audio or video signals through the home or office building standard AC electrical wiring and delivers the audio or video signals to the combined lighting and speaker fixtures.

This technology is built into ceiling mounted light fixtures, wall sconces, vanity lighting, track lighting, wall mounted mirrors, outdoor lighting, portable lighting torcheres, or table lamps.

A Home Plug transmitter chip in the base station sends the signals to a receiver chip in the lighting products. The Home Plug functionality is provided by simply plugging the base station into an existing AC outlet.

To automate of all the lighting fixture in the home or building using this system, a simple program on a laptop computer is provided to control every light fixture in the house or building to set up a lighting scheme. This provides the ability to have complete home or building lighting automation without any special wiring or lighting panel.

### BRIEF DESCRIPTION OF THE DRAWINGS

Further objects, features and advantages of the present invention will become apparent upon the consideration of the following detailed description of the presently-preferred embodiment when taken in conjunction with the accompanying drawings, wherein:

FIG. 1 is a diagrammatic view of the overall invention connected to various light fixtures, the internet, an AC outlet, and the electrical system in a home;

FIG. 2 is a diagrammatic view of the home space plug connected to a lighting fixture and the electrical system of the home;

FIG. 3 is a diagrammatic view of the home space plug connected to a lighting fixture and the electrical system of the home;

FIG. 4 is a diagrammatic view of the home space plug connected to a lighting fixture and the electrical system of the home;

FIG. 5 is a diagrammatic view of the home space plug connected to a lighting fixture and the electrical system of the home;

FIG. 6 is a diagrammatic view of the home space plug connected to a lighting fixture and the electrical system of the home;

FIG. 7 is a diagrammatic view of the home space plug connected to a lighting fixture and the electrical system of the home;

FIG. 8 is a diagrammatic view of the home space plug connected to a lighting fixture and the electrical system of the home; and

FIG. 9 is a diagrammatic view of the software panel and touch panel design.

### DETAILED DESCRIPTION OF THE PREFERRED EMBODIMENT

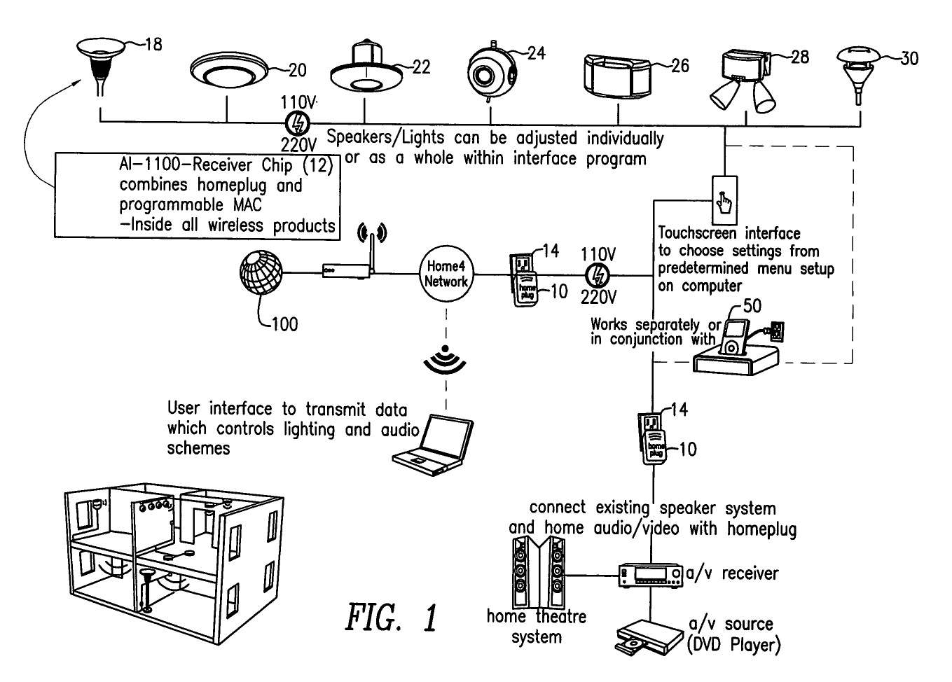

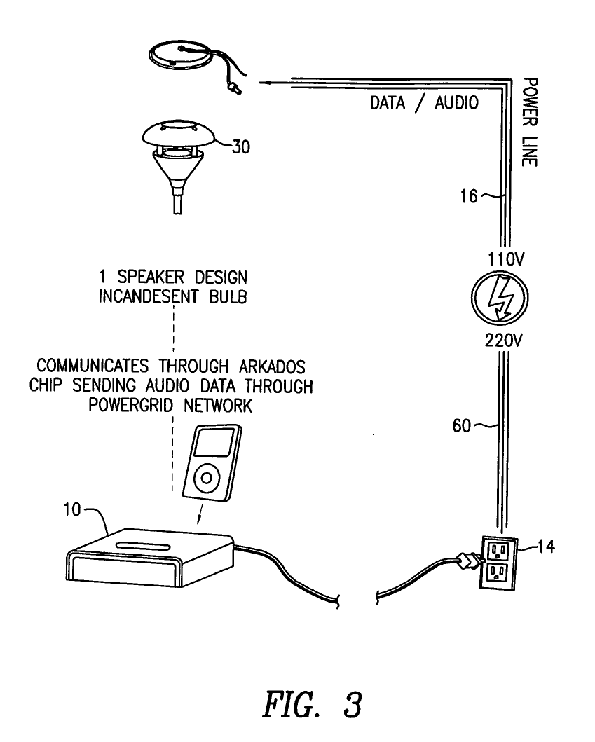

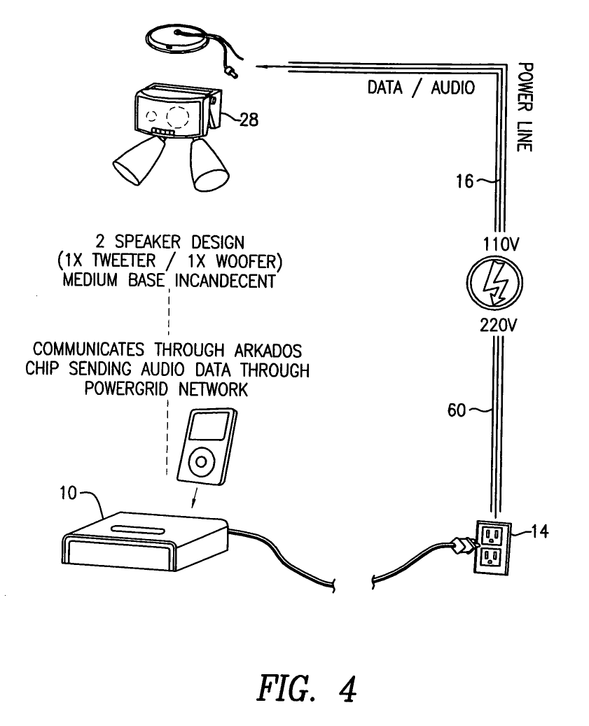

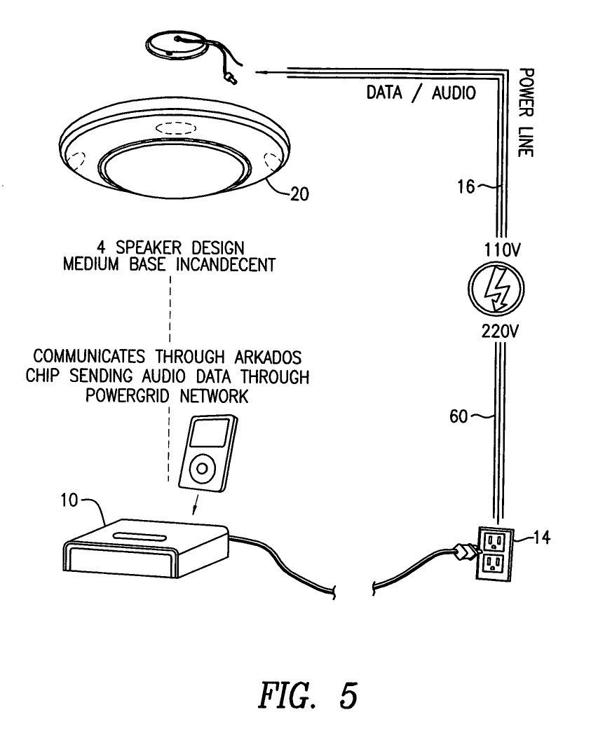

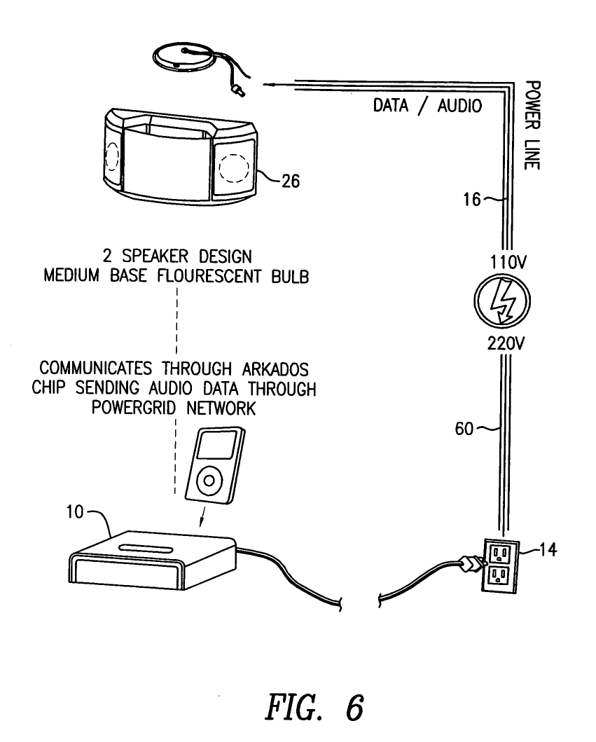

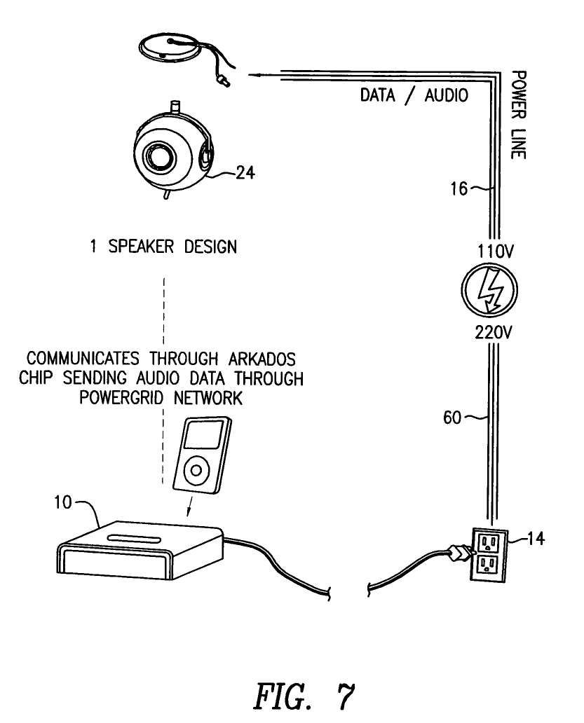

As shown in FIGS. 1 to 8, a family of lighting fixtures (Hard Wired or Portable) are provided that are based on Home Plug Technology. Each lighting fixture shown has lights and speakers built into a single unit. It should also be understood that other types of lighting fixtures may be employed with this invention.

As shown in FIG. 1, the home or building network system is connected to the internet 100, and may interface with a computer 102, and is connected to the home or building electrical system 104, as well as to lighting fixtures 18 to 30. The system includes the home plug unit 10 plugged into a wall outlet 14, as well as an MP3 player 50 placed in a docking station. Further, the system is connected to existing speakers and audio/video devices with the home plug unit 10.

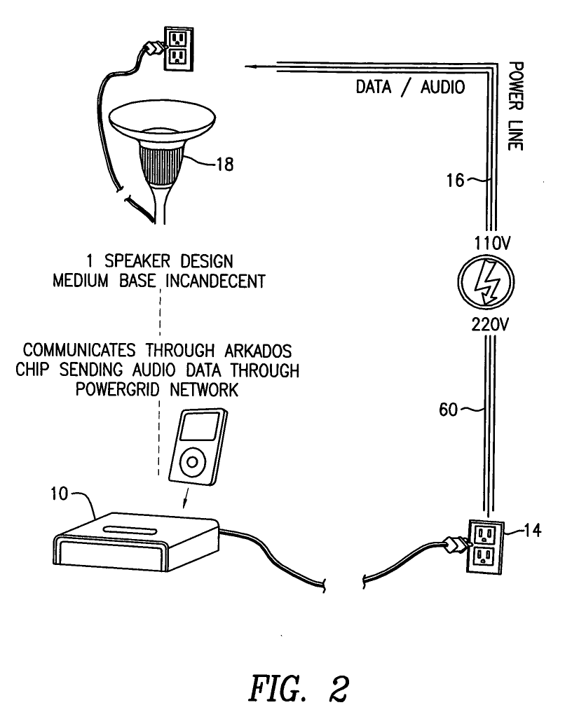

As shown in FIGS. 2 to 8, the Base station 10 includes a transmitter chip or Home Plug Chip 12 and the station 10 is plugged into the standard electrical outlet 14, and transmits audio/video and lighting signals 16 to the hardwired or portable lighting devices 18, 20, 22, 24, 26, 28, and 30. No Audio wires are needed. In addition, each of the lighting fixtures includes a receiver chip 32 for receiving signals from the transmitter chip 12.

The light and sound system includes a family of lighting and sound products that work independently or all together. The lighting products lineup include a floor lamp 18, a landscape fixture 20, flood lights 22, flush mount lights 24, wall sconces 26, track light 28, and recessed lights 30, each with speakers 40 incorporated into the lighting products.

Each lighting unit 18, 20, 22, 24, 26, 28, and 30 has an Arkados receiver chip 32 incorporated into each lighting unit for receiving audio and video signals wirelessly from the iPod or MP3 unit 50 in the base station. Each lighting fixture 18, 20, 22, 24, 26, 28, and 30 also has built into it speakers 70 for playing the transmitted audio signals.

These lighting/sound products work independently with the plug in transmitter chip 12 in base station 10 which docks an ipod 50. The audio signal from the iPod is then transmitted through the existing electrical wiring 60 to the lighting/sound units. The combined lighting and speaker units are either hard wired to the wall/ceiling or plugged into any one of the existing homes electrical outlets.

Once installed in the home, the combined light-speaker units transmit audio, video, and electrical signals via existing standard AC electrical wiring, without any audio wiring.

The base station 10 having transmitter chip 12 transmits audio signals through the home or office building standard AC electrical wiring and delivers the audio signal to the combined lighting and speaker fixture having receiver chip 12.

This technology is built into ceiling mounted fixtures, wall sconces, vanity lighting, track lighting, wall mounted mirrors, outdoor lighting, portable lighting torcheres, and table lamps.

The “Arkados” chip or transmitter chip 12 in the base station provides the lighting products the homeplug functionality by simply plugging the base station into an existing AC outlet.

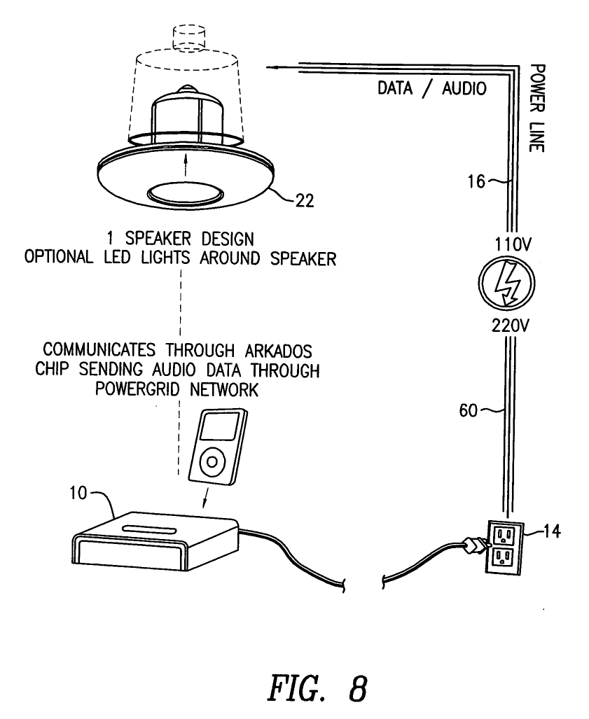

To automate all the lighting in the home or building using this system, a simple program on a laptop or computer is provided to control every light fixture in the house to set up a lighting scheme. See FIG. 8 showing the main software panel 90 for operating and controlling all the light and audio/video devices. This provides the ability to have complete home lighting automation without any special wiring or lighting panel.

### OPERATION OF THE PRESENT INVENTION

During operational use, as shown in the drawings, the installer/user hooks up the invention in the following manner:

The Base station 10 with the Arkados transmitter chip 12 is plugged into the standard electrical outlet 14 and transmits audio/video and lighting signals 16 to the hardwired or portable lighting devices 18, 20, 22, 24, 26, 28, and 30. No Audio wires are needed.

The light and sound system includes a family of lighting and sound products that work independently or all together. The lighting products lineup include a floor lamp 18, a landscape fixture 20, flood lights 22, flush mount lights 24, wall sconces 26, track light 28, and recessed lights 30, each with speakers 40 incorporated into the lighting products.

Each lighting unit 18, 20, 22, 24, 26, 28, and 30 has an Arkados receiver chip 12 incorporated into each lighting unit for receiving audio and video signals wirelessly from the iPod 50. Each lighting fixture 18, 20, 22, 24, 26, 28, and 30 also has built into it speakers 70 for playing the transmitted audio signals.

These lighting/sound products work independently with the plug in transmitter chip 12 which docks an iPod 50. The audio signal from the iPod is then transmitted through the existing electrical wiring 60 to the lighting/sound units. The combined lighting and speaker units are either hard wired to the wall/ceiling or plugged into any one of the existing homes electrical outlets.

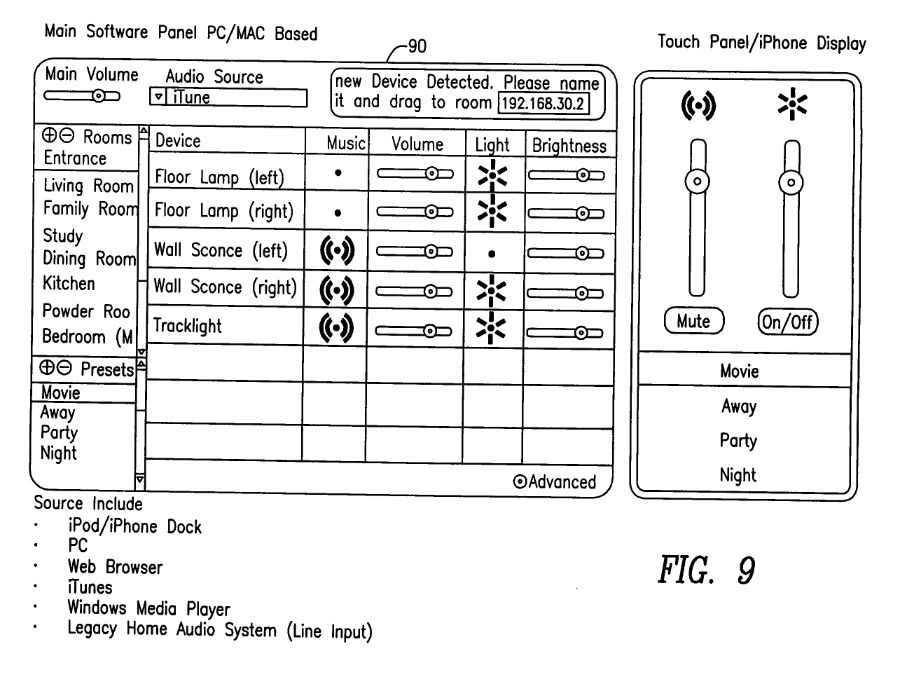

The invention includes a Mac/PC based program that controls all the devices in the home or building. The software gives the user the ability to control the light and sound out of each device, as well as set up room themes that can be triggered by the in wall touchpad or set up on a schedule, as shown in FIG. 9. The software directs multiple audio signals throughout the house from a number of existing programs on the user's computer, such as iTunes or Rhapsody.

### ADVANTAGES OF THE PRESENT INVENTION

Accordingly, an advantage of the present invention is that it provides for a light and sound system for transmitting audio/data signals over electrical wires, with the system being connected to the internet, as well as various lighting fixtures, and a control panel for controlling the system.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed:

1) A combined system for transmitting light, sound, and video signals using standard electrical AC wiring, comprising:
a) a lighting fixture having one or more built in speaker units for transmitting both light and sound;
b) each lighting/speaker unit has an Arkados receiver chip incorporated therein for receiving audio and video signals;
c) a base station for plugging into a standard electrical outlet including a transmitter chip for transmitting audio and video signals and lighting signals to said receiver chip in said lighting/speaker units, without any audio wires, wherein said base station includes a docking station for receiving an MP3 player.

2) A combined system wherein said lighting fixture is a floor lamp, a flush mount light, a recessed light, a track light, a wall sconce, or a landscape light fixture.

3) A combined system wherein said audio/video device is an MP3 player or an iPod, which is received within the docking station of said base station.

4) A combined system further including a main software panel for operating and controlling all of the light fixtures and all of the audio/video devices.
